(19) United States
(12) Patent Application Publication
(10) Pub. No.: US 2012/0124175 A1
(43) Pub. Date: May 17, 2012

(54) ATOM-BASED REALLY SIMPLE SYNDICATION (RSS) CONTENT READER SYSTEM AND METHOD, AND ATOM-BASED RSS CONTENT PROVIDING SYSTEM AND METHOD

(76) Inventors: Jin Hong Yang, Daejeon (KR); Hyeon Taek Oh, Cheongju-si (KR); Hyo Jin Park, Daejeon (KR); Jun Kyun Choi, Daejeon (KR)

(21) Appl. No.: 12/972,113

(22) Filed: Dec. 17, 2010

(30) Foreign Application Priority Data
Nov. 17, 2010 (KR) 10-2010-0114325
Nov. 17, 2010 (KR) 10-2010-0114326

(51) Int. Cl. G06F 15/16

(52) U.S. Cl. 709/219

(57) ABSTRACT

Provided are an Atom-based really simple syndication (RSS) content reader system and method, and an RSS content providing system and method. The RSS content reader system may include a feed reader module to receive a feed related to a content from a web server for providing a syndication service and to store the feed, and a feed query module to request an updated content to the web server through a query using update information of the feed.

### CROSS-REFERENCE TO RELATED APPLICATION

This application claims the benefit of Korean Patent Application No. 10-2010-0114325, filed on Nov. 17, 2010, and Korean Patent Application No. 10-2010-0114326, filed on Nov. 17, 2010, in the Korean Intellectual Property Office, the disclosures of which are incorporated herein by reference.

### BACKGROUND

1. Field of the Invention

The present invention relates to an ATOM-based really simple syndication (RSS) content reader system and method, and an ATOM-based content providing system and method, for providing a content syndication service on the web using the ATOM standard.

2. Description of the Related Art

Content syndication enables a publisher to provide users, who want to subscribe, with a convenient access to a frequently updated content by making a portion of content of a site or the entire content of the site available through other services. A syndicated content, also referred to as a feed, is composed of a content and metadata. The feed may include only a headline or a link to a content, or may include the entire content of a site.

For content syndication on the web, the use of a really simple syndication (RSS) format is rapidly increasing. In other words, an RSS service allows a user to access predetermined information of an updated content in one place, in which the user is interested, such as a title, a link, summary of the updated content, and the like, instead of collecting the updated content from many different websites. Accordingly, the user may easily read a latest content of a site without visiting the site. The RSS service becomes available when a publisher provides an extensible markup language (XML)-based RSS feed including an updated content, and a user registers a site address in an RSS reader program installed in a computer of the user, so that the user may easily read the updated content.

Recently, the trend of a reader program used to read an RSS feed moves toward an RSS web service provided through a proxy. That is, the reader program is changing from a desktop to application program that was an early client program, to a web service through a proxy due to problems related to a processing rate, a network usage amount, and the like, caused by an increased subscription amount of an RSS feed.

In a conventional RSS, an RSS reader reads an XML-based full text of an RSS feed, constructs an XML document object model (DOM) tree, and compares corresponding RSS data through the XML DOM tree to check whether the RSS data was updated, thereby checking a content not included in the RSS reader. However, this service structure causes the downloading of an entire RSS file each time. Accordingly, there is a desire for enabling an RSS reader to request only a content not read by the RSS reader, and for enabling a publisher to respond to the request.

### SUMMARY

An aspect of the present invention provides a really simple syndication (RSS) content reader system and method in which an RSS reader may execute a query for a content not read by the RSS reader using latest data information of a proxy based on the Atom standard and a publisher may provide an updated content in response to a request of the RSS reader.

Another aspect of the present invention also provides an RSS content providing system and method for providing an updated content not read by an RSS reader, based on the Atom standard and in response to a request of the RSS reader.

Additional features of the invention will be set forth in the description which follows, and in part will be apparent from the description, or may be learned by practice of the invention.

According to an aspect of the present invention, there is provided an Atom-based really simple syndication (RSS) content reader system to aggregate a content from a web server for providing a syndication service, including a feed reader module to receive a feed related to the content from the web server corresponding to a web site address registered by a subscriber and to store the feed, and a feed query module to request an updated content to the web server through a query using update information of the feed. In this instance, the RSS content reader system may be comprised of a proxy server, and the web server may provide a syndication service based on the Atom standard using a hypertext transfer protocol (HTTP)-based protocol. The update information may be used to check an update time of the feed.

The feed query module may generate an HTTP request message using the update information as an HTTP GET parameter, and transmit the HTTP request message to the web server.

After the web server recognizes the update information in the HTTP request message, the web server may generate a feed related to the updated content that was updated based on the update information, and may transmit the feed to the RSS content reader system through an HTTP response message.

The web server may allocate new update information to the generated feed, and may transmit the allocated update information to the RSS content reader system through the HTTP response message.

According to another aspect of the present invention, there is provided an Atom-based RSS content reader method of an RSS content reader system to aggregate a content from a web server for providing a syndication service, including feed reading to receive a feed related to the content from the web server corresponding to a web site address registered by a subscriber, and to store the feed, and feed querying to request an updated content to the web server through a query using update information of the feed. In this instance, the web server may provide a syndication service based on the Atom standard using an HTTP-based protocol. The update information may be used to check an update time of the feed.

According to still another aspect of the present invention, there is provided an RSS content providing system including a feed history record unit to record a content request time, when an RSS content reader requested an RSS content, in association with client information for identifying the RSS content reader, an HTTP analysis unit to receive an HTTP request message using the client information as a query from the RSS content reader, and to extract the client information, a feed update unit to generate a feed of an updated content, the updated content having been updated subsequent to the content request time corresponding to the client information, and an HTTP response unit to transmit the feed of the updated content to the RSS content reader through an HTTP response message to the HTTP request message.

The client information may include user agent information and an IP address.

The feed history record unit may change the content request time to a time when the feed was generated, based on the HTTP request message.

The HTTP request message may be a request command using the client information as an HTTP GET parameter.

According to yet another aspect of the present invention, there is provided an RSS content providing method including feed history recording to record a content request time, when an RSS content reader requested an RSS content, in association with client information for identifying the RSS content reader, HTTP analyzing to receive an HTTP request message using the client information as a query from the RSS content reader, and to extract the client information, feed updating to generate a feed of an updated content that was updated subsequent to the content request time corresponding to the client information, and HTTP responding to transmit the feed of the updated content to the RSS content reader through an HTTP response message to the HTTP request message.

According to embodiments of the present invention, an updated content, which was updated subsequent to a time when a client most recently checked an RSS content, may be provided based on the Atom standard, thereby reducing a server-side network traffic and a client-side parsing feature. In particular, a web service provider who updates a large scale of contents may get benefited more effectively.

It is to be understood that both the foregoing general description and the following detailed description are exemplary and explanatory and are intended to provide further explanation of the invention as claimed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a really simple syndication (RSS) content reader system for aggregating an RSS content based on the Atom standard according to an embodiment of the present invention.

FIG. 2 is a view illustrating a process between a web server for providing an RSS content and an RSS content reader system for requesting an updated content through a query according to an embodiment of the present invention.

FIG. 3 is a block diagram illustrating an internal structure of a web server for providing an updated content in response to a request of an RSS content reader system according to an embodiment of the present invention.

FIG. 4 is a flowchart illustrating a process for providing a request for an updated content through an Atom-based feed query in an RSS content reader system according to an embodiment of the present invention.

FIG. 5 is a flowchart illustrating a process for providing an updated content in response to a request of an RSS content reader system in a web server according to an embodiment of the present invention.

FIG. 6 is a view illustrating an RSS content providing system for providing an RSS content to an RSS content reader according to another embodiment of the present invention.

FIG. 7 is a view illustrating a process for providing an RSS content using user agent information in an RSS content providing system according to another embodiment of the present invention.

FIG. 8 is a block diagram illustrating an internal structure of an RSS content providing system for providing an updated content in response to a request of an RSS content reader according to another embodiment of the present invention.

FIG. 9 is a flowchart illustrating an RSS content providing method for providing an updated content in response to a request of an RSS content reader according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings.

### First Embodiment

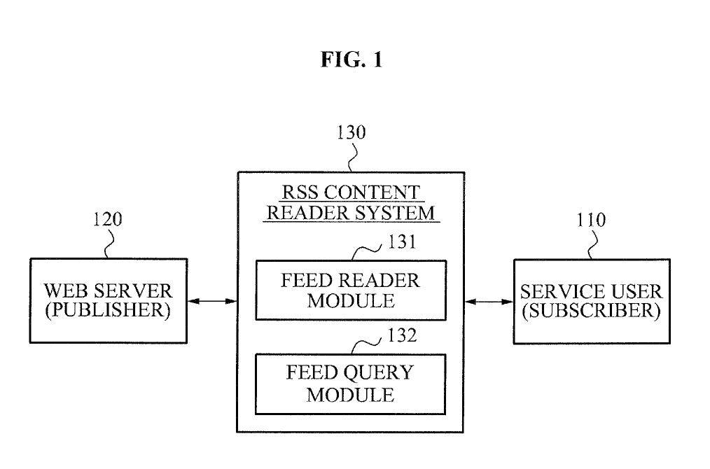

FIG. 1 is a block diagram illustrating a really simple syndication (RSS) content reader system 130 for aggregating an RSS content based on the Atom standard. Referring to FIG. 1, the RSS content reader system 130 is connected to a subscriber 110 and a web server 120 via a network.

The subscriber 110 may be a communication terminal of a user that intends to subscribe to a syndicated content (hereinafter referred to as an ‘RSS content’), and may include all communication terminals accessible to the RSS content reader system 130 via a network.

The web server 120 may be an RSS content providing system for providing a content syndication service on the web, and may provide a syndication service based on the Atom standard using a hypertext transfer protocol (HTTP)-based protocol. In other words, the web server 120 may have a unique syndication address, that is, an Atom address, and may provide a feed related to an RSS content in an extensible markup language (XML)-based document format for content syndication.

The RSS content reader system 130 may be comprised of a proxy server, and may provide a web service to the subscriber 110 through a proxy. In other words, after the RSS content reader system 130 aggregates an RSS content from the web server 120 which may support an Atom-based syndication service, the RSS content reader system 130 may transmit the aggregated RSS content to the subscriber 110. Also, the RSS content reader system 130 may request a feed of an updated RSS content (hereinafter referred to as a ‘updated content’) to the web server 120 through a query using latest data information in the RSS content reader system 130. Alternatively, the RSS content reader system 130 may be configured to be installed in the subscriber 110 rather than being configured as a proxy. In this instance, the RSS content reader system 130 may be a communication terminal for running an RSS reader program having a function provided in this embodiment of the present invention.

Referring to FIG. 1, the RSS content reader system 130 according to an embodiment of the present invention may include a feed reader module 131 and a feed query module 132.

The feed reader module 131 may aggregate a feed related to an RSS content from the web server 120 corresponding to a web site address which the subscriber 110 registered. In this instance, the feed may include one of a title and a unique address that is also referred to as a link, of a content. Alternatively, the feed may include substantially the entire content of the content. After the feed reader module 131 accesses the web server 120 and receives an RSS content using a pull or push scheme and stores the RSS content, the feed reader module 131 may provide the corresponding content to the subscriber 110 in response to a service request of the subscriber 110

The feed query module 132 may request an updated content to the web server 120 using a query based on update information of a feed. The feed based on the Atom standard may have ATOM_ID and ATOM_Updated values for each item, that is, a content, of a corresponding feed. Here, ATOM_ID represents a unique value for identifying a content, and ATOM_Updated denotes a time when a content was created. According to this embodiment, ATOM_ID and ATOM_Updated may be used as update information (hereinafter referred to as ‘ID information’) for checking an update time of a feed. In other words, when the feed query module 132 requests an updated content, the feed query module 132 may request a content created subsequent to ATOM_ID and ATOM_Updated of corresponding ID information by transmitting the ID information to the web server 120. For example, when ATOM_ID uniformly increases, the feed query module 132 may use a combination of a largest ATOM_ID value and a latest ATOM_Updated value. Here, the feed query module 132 may request only an updated content of the web server 120 rather than the entire content of the web server 120 using an HTTP GET command for transmitting data using a query string.

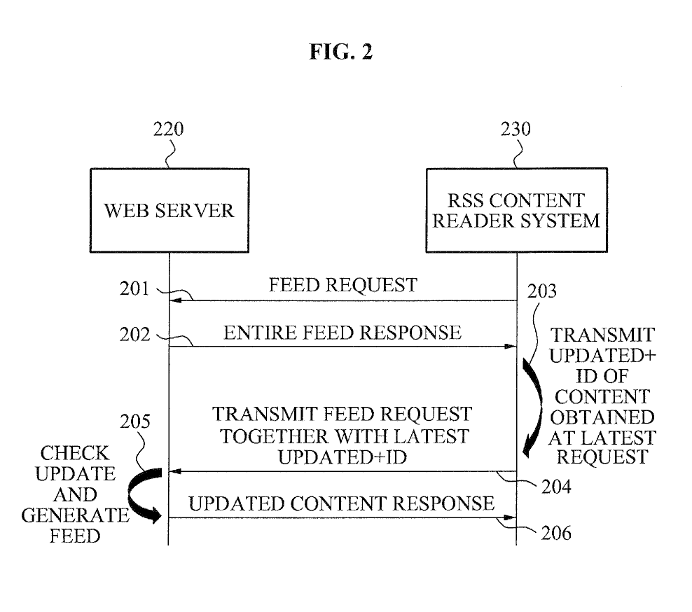

FIG. 2 is a view illustrating a process between a web server 220 for providing an RSS content and an RSS content reader system 230 for requesting an updated content through a query.

In operation 201, the RSS content reader system 230 may initially request a feed of an RSS content, to which a subscriber applied for subscription, to the web server 220.

In operation 202, the web server 220 may provide a feed of the entire content of a site to the RSS content reader system 230.

In operation 203, the RSS content reader system 230 may extract ID information from the latest obtained feed from the web server 220.

In operation 204, the RSS content reader system 230 may generate an HTTP request message using the ID information as an HTTP GET parameter, and may transmit the HTTP request message to the web server 220.

In operation 205, the web server 220 may check the ID information through the HTTP request message, and may check an updated content that was updated based on the ID information and generate a feed related to the updated content.

In operation 206, the web server 220 may transmit, to the RSS content reader system 230 a response to the HTTP request message based the updated content rather than based the entire content.

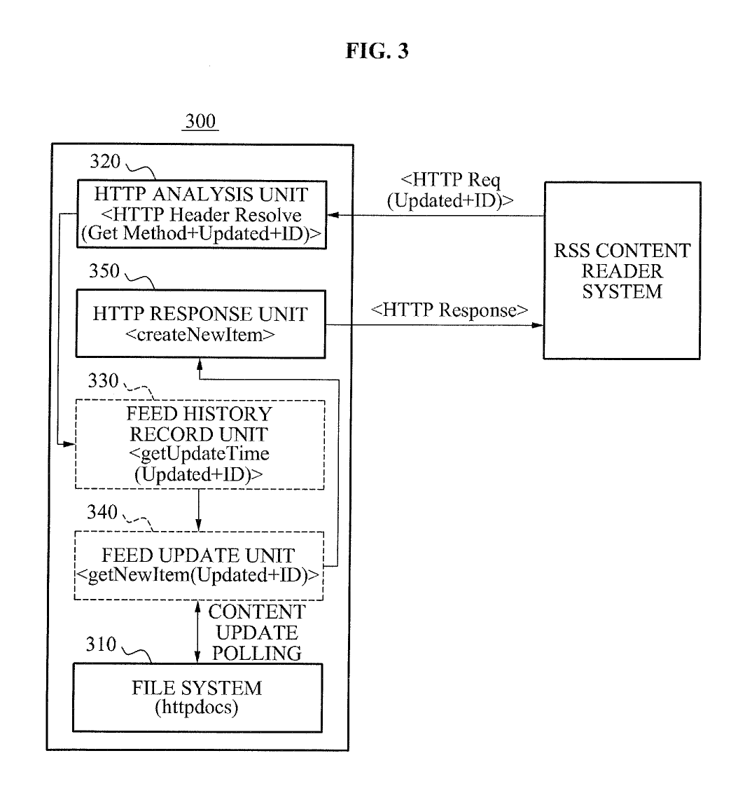

FIG. 3 is a block diagram illustrating an internal structure of a web server 300 for providing an updated content in response to a request of an RSS content reader system. Referring to FIG. 3, the web server 300 may include a file system 310, an HTTP analysis unit 320, a feed history record unit 330, a feed update unit 340, and an HTTP response unit 350.

The file system 310 may perform a database function for maintaining an HTTP-based document corresponding to an RSS content. In this instance, the file system 310 may provide a function for polling an updated content.

The HTTP analysis unit 320 may check ID information of a feed most recently checked by the RSS content reader system through an HTTP request message received from the RSS content reader system. For example, the HTTP analysis unit 320 may extract ID information corresponding to the HTTP GET by analyzing an HTTP header of the HTTP request message. Also, the HTTP analysis unit 320 may check whether an RSS content was updated subsequent to an update time corresponding to the ID information, and may request a feed generated subsequent to the update time.

When the feed history record unit 330 generates a feed of an RSS content, the feed history record unit 330 may allocate ID information to the generated feed and record the ID information. Accordingly, the feed history record unit 330 may check ATOM_ID and ATOM_Updated values corresponding to ID information checked by the HTTP analysis unit 320

The feed update unit 340 may newly generate a feed of an updated content by polling the updated content that was updated subsequent to ATOM_ID and ATOM_Updated corresponding to ID information among contents stored in the file system 310. In this instance, the feed history record unit 330 may allocate new ID information to the newly generated feed and may record the new ID information. Accordingly, after the feed update unit 340 generates a feed of an updated content in a file in response to a request of the HTTP analysis unit 320, the feed update unit 340 may read a corresponding feed of an address value by returning the address value of the feed.

The HTTP response unit 350 may include new ID information (Updated+ID) in a newly generated feed of an updated content, and may transmit the feed of the updated content to the RSS content reader system through an HTTP response message.

As described above, the RSS content reader system according to an embodiment of the present invention may request only an updated content of a site rather than the entire content of the site, through a query using ID information included in a feed of an RSS content. In response to the request, the web server 300 may check and provide a content that was updated subsequent to a time when the RSS content reader system checked the RSS content most recently, that is, a content not included in the RSS content reader system, using the ID information received from the RSS content reader system.

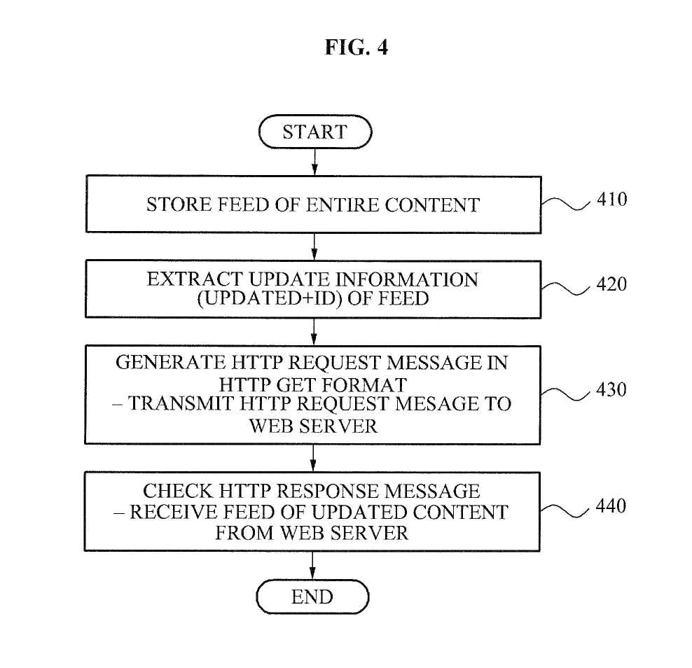

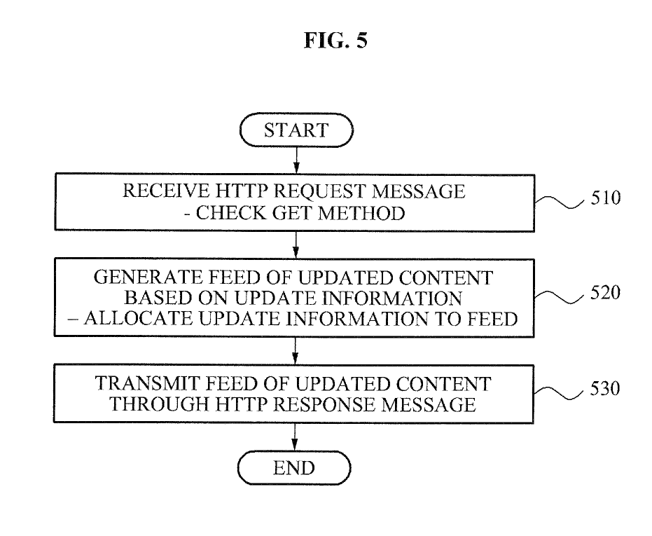

An RSS content reader method using a feed query according to an embodiment of the present invention is described with reference to FIGS. 4 and 5. Each operation of the RSS content reader method according to the present embodiment of the present invention may be performed by the web server 120 and the RSS content reader system 130 of FIG. 1.

FIG. 4 is a flowchart illustrating a process for requesting an updated content to the web server 120, in the RSS content reader system 130.

In operation 410, when the RSS content reader system 130 initially requests a feed of an RSS content to which a subscriber applied for subscription, the RSS content reader system 130 may receive a feed of the entire content of a site from the web server 120 and store the feed. The feed provided from the web server 120 may include ID information (Updated+ID).

In operation 420, the RSS content reader system 130 may extract ID information from the latest obtained feed.

In operation 430, the RSS content reader system 130 may generate an HTTP request message using the ID information as an HTTP GET parameter, and may transmit the HTTP request to the web server 120. In this instance, the RSS content reader system 130 may request only an updated content of a site rather than the entire content of the site through a query using ID information of a feed.

In operation 440, the RSS content reader system 130 may receive a feed related to an updated content through an HTTP response message received from the web server 120 in response to the HTTP request message.

FIG. 5 is a flowchart illustrating a process for providing an updated content in response to a request of the RSS content reader system 130, in the web server 120.

In operation 510, the web server 120 may receive the HTTP request message from the RSS content reader system 130, and may check ID information of a feed, which was transmitted to the RSS content reader system 130 lately, by checking HTTP GET method in the HTTP request message.

In operation 520, the web server 120 may generate a feed of an updated content that was updated recently based on the ID information. In other words, the web server 120 may generate a feed of an update content that was updated subsequent to an update time corresponding to the ID information. In this instance, when the web server 120 generates a feed of an RSS content, the web server 120 may allocate new ID information to the generated feed.

In operation 530, the web server 120 may include the new ID information in the newly generated feed of the updated content, and may transmit the feed of the updated content to the RSS content reader system 130 through an HTTP response message. In other words, after the web server 120 receives a query using ID information of a feed from the RSS content reader system 130, the web server 120 may provide a response based on an updated content that is not included in the RSS content reader system 130.

### Second Embodiment

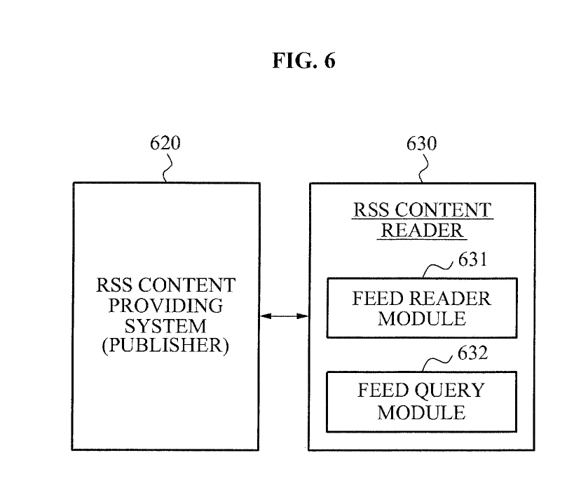

FIG. 6 is a view illustrating an RSS content providing system 620 for providing an RSS content. Referring to FIG. 6, the RSS content providing system 620 may provide an RSS content to an RSS content reader 630.

The RSS content providing system 620 may provide a content syndication service on the web, and may provide a syndication service based on the Atom standard using an HTTP-based protocol. In other words, the RSS content providing system 620 may have a unique syndication address, that is, an Atom address, and may provide a feed related to an RSS content in an XML-based document format for content syndication.

The RSS content reader 630 may be a feed reader client, and may aggregate an RSS content from the RSS content providing system 620 which may support an Atom-based syndication service. As an example, the RSS content reader 630 may be a communication terminal of a user that intends to subscribe to an RSS content, that is, a communication terminal for running an RSS reader program. As another example, the RSS content reader 630 may be a proxy server for providing an RSS content to a user using a web service through a proxy.

Specifically, the RSS content reader 630 may include a feed reader module 631 and a feed query module 632, as shown in FIG. 6.

The feed reader module 631 may aggregate a feed related to an RSS content from a web server corresponding to a web site address which a user registered, that is, from the RSS content providing system 620, and may store the feed. Here, the feed may include one of a title and a unique address that is also referred to as a link of a content. Alternatively, the feed may include substantially the entire content of the content. The feed reader module 631 may access the RSS content providing system 620, and may receive and store an RSS content using a pull or push scheme and provide a corresponding content in response to a request of the user.

The feed query module 632 may request a feed of an RSS content to the RSS content providing system 620 through a query using client information for identifying the RSS content reader 630. In this instance, the client information may include user agent information and an IP address. Here, the user agent information may be a value basically used for all browsers to make an HTTP request, and generally may include browser information such as a type, a version, an operating system of a browser, and the like. In other words, when the feed query module 632 requests an RSS content, the feed query module 632 may provide user agent information and an IP address to the RSS content providing system 620. For example, the feed query module 632 may request an RSS content to the RSS content providing system 620 using an HTTP GET command for transmitting data using a query string.

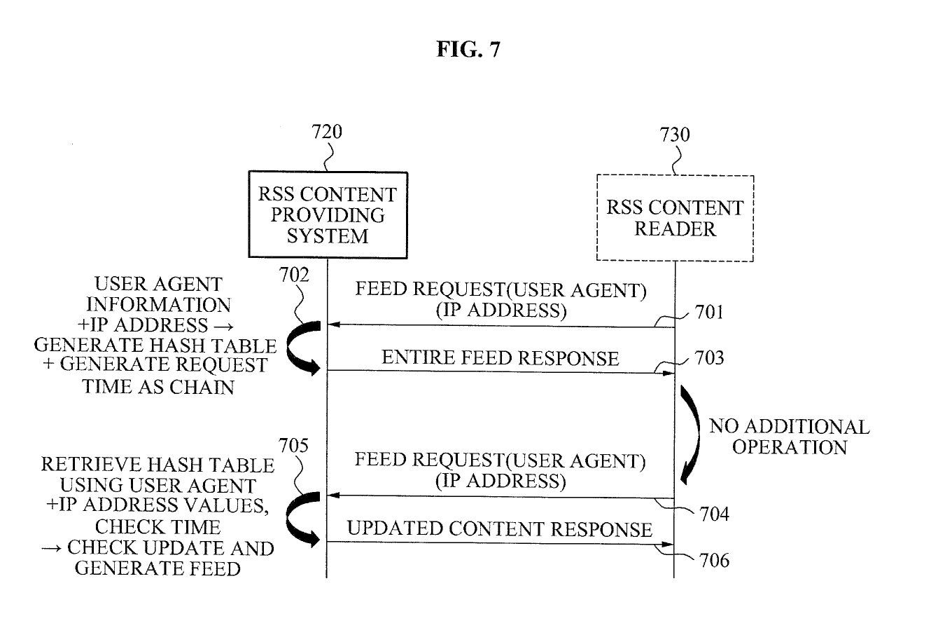

FIG. 7 is a view illustrating a process for providing an RSS content using user agent information in an RSS content providing system 720.

In operation 701, an RSS content reader 730 may generate an HTTP request message using user agent information and an IP address as an HTTP GET parameter in response to a request for an RSS content to which a user applied for subscription, and may transmit the HTTP request message to the RSS content providing system 720.

In operation 702, the RSS content providing system 720 may receive the HTTP request message, may check the user agent information and the IP address in the HTTP request message, and may record the user agent information and the IP address in association with a content request time when the RSS content reader 730 requested an RSS content, that is, a time when the RSS content providing system 720 received the HTTP request message.

In operation 703, when the request is an initial request for an RSS content, the RSS content providing system 720 may provide a feed of the entire content of a site to the RSS content reader 730.

When the RSS content providing system 720 receives an HTTP request message from the RSS content reader 730 in operation 704, the RSS content providing system 720 may check the user agent information and the IP address in the HTTP request message, and may check the content request time corresponding to the user agent information and the IP address, in operation 705. Also, the RSS content providing system 720 may check a content (hereinafter referred to as a ‘updated content’) that was updated subsequent to the checked content request time, and may generate a feed related to the updated content.

In operation 706, the RSS content providing system 720 may provide a response to the HTTP request message based on the updated content by transmitting the feed related to the updated content to the RSS content reader 730. Accordingly, subsequent to initial request for an RSS content, the RSS content providing system 720 may provide only an updated content of a site rather than the entire content of the site.

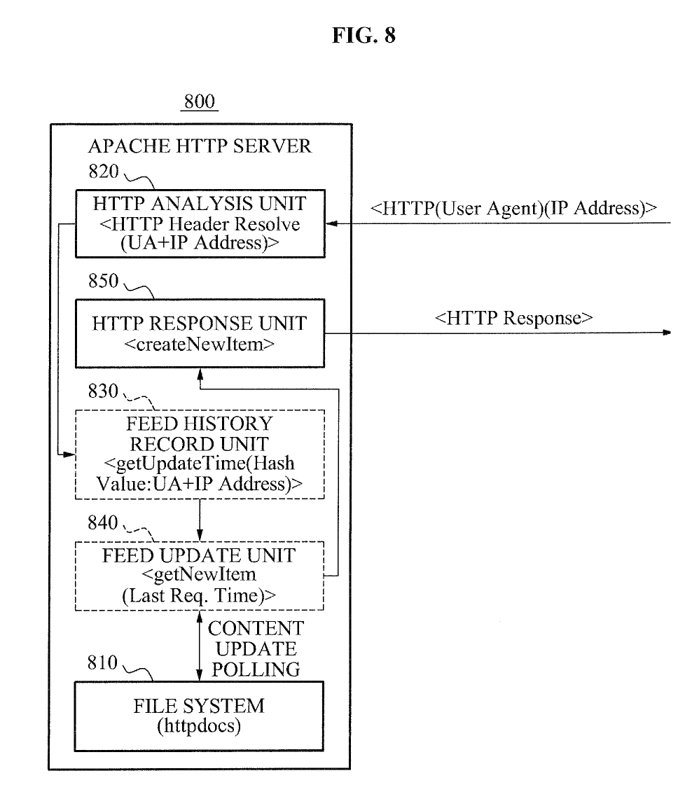

FIG. 8 is a block diagram illustrating an internal structure of an RSS content providing system 800 for providing an updated content in response to a request of an RSS content reader. Referring to FIG. 8, the RSS content providing system 800 may include a file system 810, an HTTP analysis unit 820, a feed history record unit 830, a feed update unit 840, and an HTTP response unit 850.

The file system 810 may perform a database function for maintaining an HTTP-based document corresponding to an RSS content. In this instance, the file system 810 may provide a function for polling an updated content.

The HTTP analysis unit 820 may check user agent information and an IP address through an HTTP request message received from the RSS content reader. For example, the HTTP analysis unit 820 may extract user agent information and an IP address corresponding to HTTP GET by analyzing an HTTP header of the HTTP request message.

The feed history record unit 830 may generate a hash table by combining the user agent and the IP address checked by the HTTP analysis unit 820. Furthermore, the feed history record unit 830 may generate chains in which a time when the HTTP analysis unit 820 received the HTTP request message is associated with the user agent information and the IP address. Accordingly, the feed history record unit 830 may check a content request time corresponding to the user agent information and the IP address using the hash table. Also, the feed history record unit 830 may request a feed of an updated content that was updated subsequent to a corresponding time based on the checked content request time.

The feed update unit 840 may newly generate a feed of an updated content by polling the updated content that was updated subsequent to a content request time corresponding to user agent information and an IP address among contents stored in the file system 810. In other words, the feed update unit 840 may check an updated content not included in the RSS content reader, based on a time when the RSS content reader most recently requested an RSS content. After the feed update unit 840 generates a feed of an updated content in a file, the feed update unit 840 may read a corresponding feed of an address value by returning the address value of the feed. In this instance, the feed update unit 840 may change the content request time recorded in association with the user agent information and the IP address to a time when the feed was newly generated.

The HTTP response unit 850 may transmit a newly generated feed of an updated content to the RS content reader through an HTTP response message.

As described above, when the RSS content reader requests an RSS content, the RSS content reader may provide client information to the RSS content providing system 800 so that the RSS content providing system 800 may identify a client. In this instance, because the RSS content providing system 800 records the client information in association with a content request time, the RSS content providing system 800 may check a time when the RSS content reader checked a content lately, and may check and provide a content that was updated subsequent to the time, that is, a content not included in the RSS content reader.

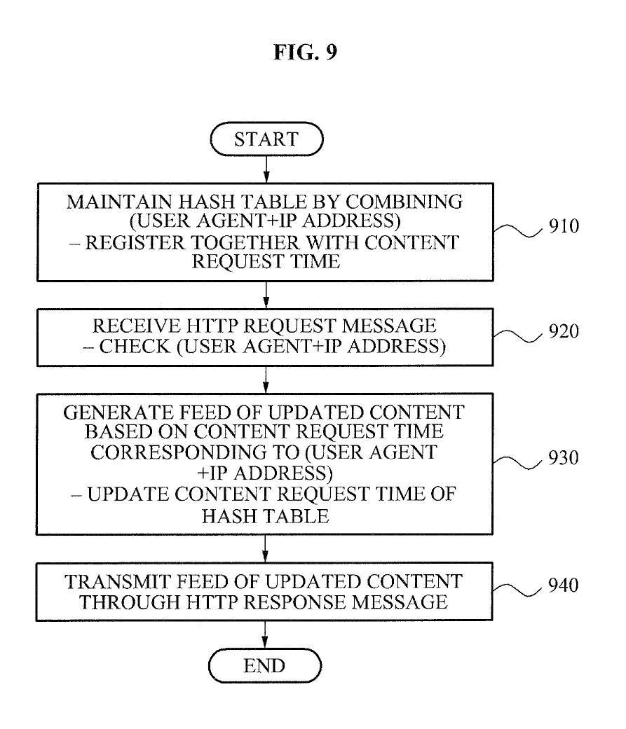

FIG. 9 is a flowchart illustrating an RSS content providing method for providing an updated content in response to a request of an RSS content reader. Each operation of the RSS content providing method according to this embodiment of the present invention may be performed by the RSS content providing system 800 of FIG. 8.

In operation 910, the RSS content providing system 800 may maintain a hash table by combining user agent information and an IP address provided from an RSS content reader when the RSS content reader requests an RSS content. In this instance, the RSS content providing system 800 may record, in the hash table, a content request time when the RSS content reader requested an RSS content in association with the user agent information and the IP address.

In operation 920, the RSS content providing system 800 may receive, from the RSS content reader, an HTTP request message using the user agent information and the IP address as an HTTP GET command. In this instance, the RSS content providing system 800 may check the user agent information and the IP address by checking HTTP GET METHOD in the received HTTP request message.

In operation 930, the RSS content providing system 800 may check the content request time corresponding to the user agent information and the IP address using the hash table. That is the RSS content providing system 800 may check a time when the RSS content reader most recently requested an RSS content, through the user agent information and the IP address. Also, the RSS content providing system 800 may generate a feed of an updated content that was updated subsequent to a corresponding time based on the checked content request time. In this instance, the RSS content providing system 800 may change the content request time of the hash table to a time when the feed was newly generated.

In operation 940, the RSS content providing system 800 may transmit the newly generated feed of the updated content to the RSS content reader through an HTTP response message. In other words, after the RSS content providing system 800 receives a query using user agent information and an IP address from the RSS content reader, the RSS content providing system 800 may make a response based on an updated content that is not included in the RSS content reader.

According to the embodiments of the present invention, when a reader client provides a web service of an RSS content using update information of the RSS content, the network bandwidth of a server may be entirely reduced. Also, because an updated content of a site rather than the entire content of the site is provided, an application range may include updating new broadcast information in a client environment such as a smart TV, and the like, thereby decreasing a server traffic and significantly reducing a client-side parsing feature.

Although a few exemplary embodiments of the present invention have been shown and described, the present invention is not limited to the described exemplary embodiments. Instead it would be appreciated by those skilled in the art that changes may be made to these exemplary embodiments without departing from the principles and spirit of the invention, the scope of which is defined by the claims and their equivalents.

What is claimed is:

1. A really simple syndication (RSS) content reader system to aggregate a content from a web server for providing a syndication service, the web server to provide the syndication service based on the Atom standard using a hypertext transfer protocol (HTTP)-based protocol, the RSS content reader system comprising:
a feed reader module to receive a feed related to the content from the web server corresponding to a web site address registered by a subscriber and to store the feed; and
a feed query module to request an updated content to the web server through a query using update information of the feed,
wherein the update information is used to check an update time of the feed, and the update information is included in the feed and received from the web server.

2. The RSS content reader system of claim 1, wherein the RSS content reader system is comprised of a proxy server.

3. The RSS content reader system of claim 1, wherein the feed query module generates an HTTP request message using the update information as an HTTP GET parameter, and transmits the HTTP request message to the web server.

4. The RSS content reader system of claim 3, wherein after the web server recognizes the update information in the HTTP request message, the web server generates a feed related to the updated content that was updated based on the update information, and transmits the feed to the RSS content reader system through an HTTP response message.

5. The RSS content reader system of claim 4, wherein the web server allocates new update information to the generated feed, and transmits the allocated update information to the RSS content reader system through the HTTP response message.

6. A really simple syndication (RSS) content reader method of an RSS content reader system to aggregate a content from a web server for providing a syndication service, the web server to provide the syndication service based on the Atom standard using a hypertext transfer protocol (HTTP)-based protocol, the method comprising:
feed reading to receive a feed related to the content from the web server corresponding to a web site address registered by a subscriber, and to store the feed; and
feed querying to request an updated content to the web server through a query using update information of the feed,
wherein the update information is used to check an update time of the feed, and the update information is included in the feed and received from the web server.

7. The method of claim 6, wherein the feed querying comprises generating an HTTP request message using the update information as an HTTP GET parameter, and transmitting the HTTP request message to the web server.

8. The method of claim 7, further comprising:
receiving a feed related to the updated content from the web server through an HTTP response message;
wherein after the web server recognizes the update information in the HTTP request message, the web server generates a feed related to the updated content that was updated based on the update information, and transmits the feed to the RSS content reader system through the HTTP response message.

9. The method of claim 8, further comprising:
receiving update information allocated to the generated feed from the web server through the HTTP response message,
wherein the web server allocates new update information to the generated feed, and transmits the newly allocated update information to the RSS content reader system through the HTTP response message.

10. A really simple syndication (RSS) content providing system to provide an RSS content to an RSS content reader, the RSS content providing system comprising:
a feed history record unit to record a content request time, when the RSS content reader requests the RSS content, in association with client information for identifying the RSS content reader;
a hypertext transfer protocol (HTTP) analysis unit to receive an HTTP request message using the client information as a query from the RSS content reader, and to extract the client information;
a feed update unit to generate a feed of an updated content, the updated content having been updated subsequent to the content request time corresponding to the client information; and
an HTTP response unit to transmit the feed of the updated content to the RSS content reader through an HTTP response message to the HTTP request message.

11. The RSS content providing system of claim 10, wherein the client information includes user agent information and an IP address.

12. The RSS content providing system of claim 10, wherein the feed history record unit changes the content request time to a time when the feed was generated, based on the HTTP request message.

13. The RSS content providing system of claim 10, wherein the HTTP request message is a request command using the client information as an HTTP GET parameter.

14. A really simple syndication (RSS) content providing method of an RSS content providing system to provide an RSS content to an RSS content reader, the method comprising:
feed history recording to record a content request time, when the RSS content reader requested the RSS content, in association with client information for identifying the RSS content reader;
hypertext transfer protocol (HTTP) analyzing to receive an HTTP request message using the client information as a query from the RSS content reader, and to extract the client information;
feed updating to generate a feed of an updated content that was updated subsequent to the content request time corresponding to the client information; and
HTTP responding to transmit the feed of the updated content to the RSS content reader through an HTTP response message to the HTTP request message.

15. The method of claim 14, wherein the client information includes user agent information and an IP address.

16. The method of claim 14, wherein the feed history recording comprises changing the content request time to a time when the feed was generated, based on the HTTP request message.

17. The method of claim 14, wherein the HTTP request message is a request command using the client information as an HTTP GET parameter.
